(19) United States
(12) Patent Application Publication
(10) Pub. No.: US 2003/0161608 A1
(43) Pub. Date: Aug. 28, 2003

(54) Image reproducing apparatus and image reproducing method

(75) Inventors: Toyoki Nishijima, Odawara-shi (JP); Kazuhiro Miyazawa, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/368,661

(22) Filed: Feb. 19, 2003

(30) Foreign Application Priority Data
Feb. 22, 2002 (JP) JP2002-046952

(51) Int. Cl. H04N 9/89

(52) U.S. Cl. 386/20

(57) ABSTRACT

An image reproducing apparatus is provided with an image input device to input image data provided with additional information data; a plurality of different type image output devices; a profile storing device to store a plurality of image correcting profiles each of which is prepared for a corresponding one of the plurality of different type output devices and corrects the image characteristic of the image data to conform with the image reproducing performance of the corresponding image output device; a selecting device to select one of the plurality of different type image output devices and one the plurality of image correcting profiles on a basis of the additional information data of the image data; and an image processing device to correct the image data with the selected image correcting profile and to reproduce an image on a basis of the corrected image data.

### BACKGROUND OF THE INVENTION

The present invention relates a method cable of reproducing picture images according to their shooting circumstances and a device thereof.

Conventionally, a method has been widely adopted to perform predetermined processes on image data that was entered through an input device such as a scanner and an image reader before sending it to output media (such as photographic printing paper) on an output device such as a printer so that the picture images may be well accepted by the user. In the description below, “reproducing image data” means to send image data to said output device for reproduction (or to send image data to output media via said output device).

Recently, personal computers and workstations have been dramatically developed and consequently various image reproducing means have been widely used such as an open system (for example a system that receives image data scanned by an image reading unit, processes it on a workstation, and reproduces images on a CRT screen and a printer) comprising some kinds of input devices (scanners, image readers, and the like) and/or output devices (printers, display, and the like), and a system that captures a single original image by an image reading unit and a digital camera, processes the captured image data individually on a workstation, and reproduces it.

As characteristics of the above input and output devices are specific to their types, there may be differences (in colors, densities, and image configuration) between an original image and an image reproduced from its image data in an image reproducing system that controls some kinds of input and output devices.

To solve these problems, the International Color Consortium (ICC) has set up an image reproducing method called ICC Profile Format Specification (hereinafter abbreviated as ICCPFS). This image reproducing method comprises storing a conversion table for converting RGB image data into a CIE (Commission International de I'Eclairage) XYZ color system and a 3×3 matrix data as profiles in advance in an image reproducing device, processing the RGB image data captured by an input device into XYZ color system image data by these profiles, converting these XYZ color system image data into image data for the output device (such as RGB image data or CMYK image data), and outputting the resulting image data to the output device. With this, the image reproduced from image data can have the same impression as the original image has independently of characteristics of input and output devices.

In accordance with said ICCPFS, particularly in printing workflow of image data taken by a camera unit such as a digital camera that stores image data in a recording medium like internal memory or IC card and displays it on a printer or monitor, the image made by processing the image data successfully by the ICCPFS is expected to have the same high image quality as the image printed out from a negative film.

For example, Japanese Application Patent Laid-Open Publication No. Hei 10-51641 discloses a method of performing the above profile processing on respective input and output devices and reproducing stable images of the same impression from image data of the original image independently of the types of the input and output devices.

Digital cameras perform gray-scale conversion, automatic exposure (AE) control assuming the image data is displayed on a monitor screen, and automatic white balance (AWB) control on image data. These gray-scale conversion, AE, and AWB processes are specific to camera manufacturers and types. Therefore, it has been difficult to reproduce high-quality printout images having the same image quality as the original images from all image data. To solve this problem, Japanese Application Patent Laid-Open Publication No. Hei 11-220687 discloses an image processing method that performs gray-scale compensation and tonal correction fit to the type of digital camera to eliminate color differences (gray-scale characteristics and color characteristics) among digital camera types.

Further, U.S. Pat. No. 5,913,014 discloses another image reproducing method that converts signals from an input device into subject densities, defines gray-scale characteristics fit for printing out, and thus provides high-quality printout images.

As described above, various image reproducing methods have been sought and proposed to reproduce images independently of input and output device types and to stabilize image reproduction.

However, the above conventional image reproducing methods and their devices have problems described below.

The above conventional image reproducing methods and their devices are designed to compensate for differences among characteristics of output device types and actualize rather good image reproduction on output devices that are not preferable to image data. To reproduce images of higher qualities from image data, these conventional image reproducing methods and their devices must be improved further.

Furthermore, the output media have been diverse and camera users can select any desired output media. This makes combinations of shooting conditions, output devices, and output media more complicated. In this case, output media that are not preferable to the shooting conditions may be specified in combination.

### SUMMARY OF THE INVENTION

It is an object of the present invention to provide an image reproducing method and device that can always output preferable reproduced images according to various shooting conditions, output devices, and output media.

To accomplish the above object, the present invention in Item 1 is characterized by

An image reproducing device comprising an input device for entering image data, an image processing means for processing image data sent from said input device, and a plurality of output devices for outputting image data that are processed by said image processing means: wherein said image reproducing device further comprises

an output device selecting means for selecting a device to which a selected image data is output among a plurality of output devices according to preset data attached to said image data

a profile recording means for recording an image correction profile to correct image characteristics of said image data for said output device in each of said output devices,

a profile selecting means for selecting an image correction profile for an output device selected by said output device selecting means among image correction profiles that are recorded by said profile recording means

an image processing controlling means for controlling said image processing means to process said image data according to the image correction profile selected by said profile selecting means, and

an output control means for controlling so that image data processed by said image processing means under control of said image processing controlling means may be output to the output device selected by said output device selecting means.

The present invention in Item 2 is characterized by

An image reproducing device in accordance with claim 1, wherein

said attached data contains data about the ratio of area of a major subject in the image, data about the focal length in shooting, data about a shooting scene type, data about an input device type, and data about the number of pixels of image data and

said output device selecting means selects an output device according to at least one of elements in said attached data.

The present invention in Item 4 is characterized by an image reproducing device comprising an input device for entering image data and an image processing means for processing image data sent from said input device, and capable of outputting image data processed by said image processing means to a plurality of output media: wherein said image reproducing device further comprises

an output medium selecting means for selecting a medium to which a selected image data is output among a plurality of output media according to preset data attached to said image data

a profile recording means for recording an image correction profile to correct image characteristics of said image data for said output medium in each of said output media,

a profile selecting means for selecting an image correction profile for an output device selected by said output medium selecting means among image correction profiles that are recorded by said profile recording means

an image processing controlling means for controlling said image processing means to process said image data according to the image correction profile selected by said profile selecting means, and

an output control means for controlling so that image data processed by said image processing means under control of said image processing controlling means may be output to the output medium selected by said output medium selecting means.

The present invention in Item 5 is characterized by

an image reproducing device in accordance with claim 4, wherein

said attached data contains data about the ratio of area of a major subject in the image, data about the focal length in shooting, data about a shooting scene type, data about an input device type, and data about the number of pixels of image data and

said output medium selecting means selects an output medium according to at least one of elements in said attached data.

The present invention in Item 6 is characterized by

an image reproducing device in accordance with any one of claims 1 to 5, wherein said image reproducing device is further equipped with a means for changing the content of an image correction file selected by said profile selecting means.

The present invention in Item 10 is characterized by

an image reproducing method comprising the steps of capturing image data from an input device, processing said captured image data and outputting it through one of a plurality of pre-installed output devices: wherein said method further comprises the steps of

selecting an output device to which said image data is output among said output devices according to preset data attached to said image data,

recording an image correction profile to correct image characteristics of said image data for said output device in each of said output devices,

selecting an image correction profile for an output device selected at said output device selecting step among image correction profiles that are recorded at said profile recording step

processing said image data according to the image correction profile selected at said profile selecting step, and

outputting image data processed at said image processing step to the output device selected at said output device selecting step.

The present invention in Item 11 is characterized by

an image reproducing method in accordance with claim 10 wherein

said attached data contains data about the ratio of area of a major subject in the image, data about the focal length in shooting, data about a shooting scene type, data about an input device type, and data about the number of pixels of image data and

said output device selecting step selects said output device according to at least one of elements in said attached data.

The present invention in Item 13 is characterized by

an image reproducing method comprising the steps of capturing image data from an input device, processing said captured image data and outputting it to one of a plurality of pre-installed output media: wherein said method further comprises the steps of

selecting an output medium to which said image data is output among said output media according to preset data attached to said image data,

recording an image correction profile to correct image characteristics of said image data for said output medium in each of said output media,

selecting an image correction profile for an output medium selected at said output medium selecting step among said recorded correction profiles

processing said image data according to the image correction profile selected at said profile selecting step, and

outputting image data processed at said image processing step to the output medium selected at said output medium selecting step.

The present invention in Item 14 is characterized by

an image reproducing method in accordance with claim 13 wherein

said attached data contains data about the ratio of area of a major subject in the image, data about the focal length in shooting, data about a shooting scene type, data about an input device type, and data about the number of pixels of image data, and

said output medium selecting step selects said output medium according to at least one of elements in said attached data.

The present invention in Item 15 is characterized by

an image reproducing method in accordance with any one of claims 10 to 14, wherein said method further comprises a step for changing the content of the image correction profile selected at said profile selection step according to said attached data.

With these characteristics, the present invention automatically selects an optimum output device or medium according to shooting conditions and automatically changes the content of the image correction profile to be fit for the selected output device or medium. Consequently, the present invention can always enable optimum image reproduction and outputting of high quality reproduced images.

The present invention in Item 7 is characterized by

an image reproducing device comprising an input device for entering image data and an image processing means for processing image data sent from said input device, and capable of outputting image data processed by said image processing means to a plurality of output media: wherein said image reproducing device further comprises

a profile recording means for recording an image correction profile to correct image characteristics of said image data for said output medium in each of said output media,

a profile selecting means for selecting an image correction profile for a specified output device among image correction profiles that are recorded by said profile recording means

an image processing controlling means for controlling said image processing means to process said image data according to the image correction profile selected by said profile selecting means, and

an output control means for controlling so that image data processed by said image processing means under control of said image processing controlling means may be output to said specified output medium.

The present invention in Item 8 is characterized by

an image reproducing device in accordance with claim 7, wherein said device further comprises a means for changing the content of the image correction profile selected by said profile selection means according to preset attached data in said image data.

The present invention in Item 9 is characterized by

an image reproducing method in accordance with claim 8 wherein

said attached data contains data about the ratio of area of a major subject in the image, data about the focal length in shooting, data about a shooting scene type, data about an input device type, and data about the number of pixels of image data, and

said changing means changes the content of said image correction profile according to at least one of elements in said attached data.

The present invention in Item 16 is characterized by

an image reproducing method comprising the steps of capturing image data from an input device, processing said captured image data and outputting it to one of a plurality of pre-installed output media: wherein said method further comprises the steps of

recording an image correction profile to correct image characteristics of said image data for said output medium in each of said output media,

selecting an image correction profile for a selected output medium among said recorded correction profiles

processing said image data according to the image correction profile selected at said profile selecting step, and

outputting image data processed at said image processing step to said specified output medium.

The present invention in Item 17 is characterized by

an image reproducing method in accordance with claim 16, wherein said method further comprises a step for changing the content of the image correction profile selected by said profile selection means according to preset attached data in said image data.

The present invention in Item 18 is characterized by

an image reproducing method in accordance with claim 16 wherein

said attached data contains data about the ratio of area of a major subject in the image, data about the focal length in shooting, data about a shooting scene type, data about an input device type, and data about the number of pixels of image data, and

said changing step changes the content of said image correction profile according to at least one of elements in said attached data.

Furthermore, the output media have been diverse and camera users can select any desired output media. This makes combinations of shooting conditions and output media more complicated. The present invention can always enable optimum image reproduction and outputting of high quality images according to the specified output media and shooting conditions

The present invention in Item 3 is characterized by

an image reproducing device in accordance with any one of claims 1 and 2, wherein

said device further comprises an output device specific to a portable/mobile terminal;

an image correction profile for the output device is recorded by said profile recording means;

said output device selecting means selects the output device specific to a portable/mobile terminal when said input device is of the portable/mobile terminal type; and

said profile selecting means selects said image correction profile for the output device specific to a portable/mobile terminal.

The present invention in Item 12 is characterized by

an image reproducing method in accordance with any one of claims 10 and 11, wherein

said output device selecting means selects the output device specific to a portable/mobile terminal when said input device is of the portable/mobile terminal type; and

said profile selecting means selects said image correction profile for the output device specific to a portable/mobile terminal.

Therefore, when said input device is of the portable/mobile terminal type, the image reproducing device in accordance with the present invention selects an output device or medium and an image correction profile for the portable/mobile terminal in advance and can reproduce optimum images from image data coming from the portable/mobile terminal. Consequently, high quality reproduction images can be output. Further, the present invention can perform reproduction of images from the portable/mobile terminal collectively on the output device, medium, and image correction profile specific for the portable/mobile terminal. This can increase the efficiency in image reproduction.

### BRIEF DESCRIPTION OF THE DRAWINGS

FIG. 1 is a functional diagram of the inside of the image reproducing device 100 in accordance with the present invention.

FIG. 2 is an operational diagram of the image reproducing method of the image reproducing device 100 in accordance with the present invention.

### DETAILED DESCRIPTION OF THE PREFERRED EMBODIMENT

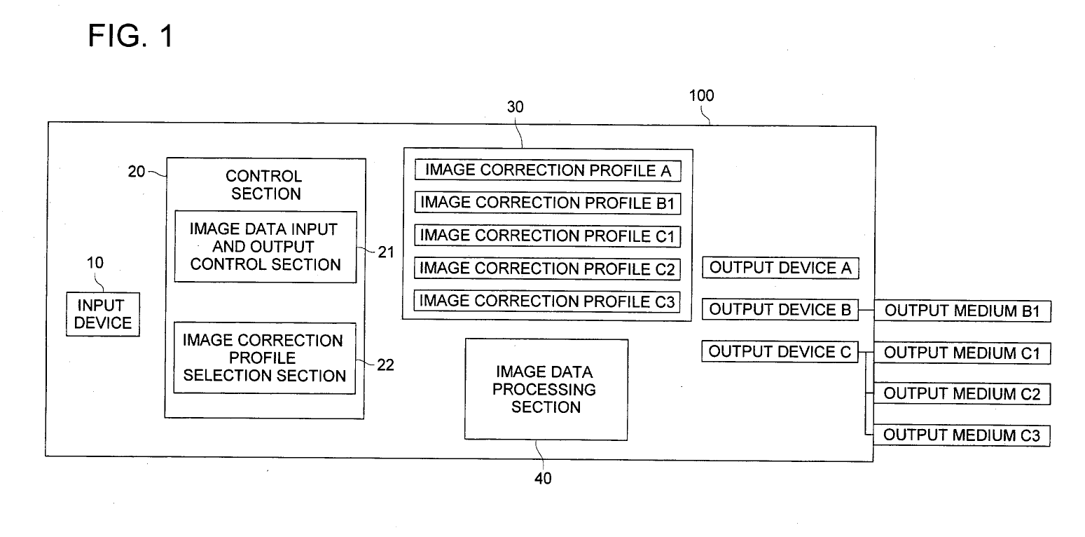

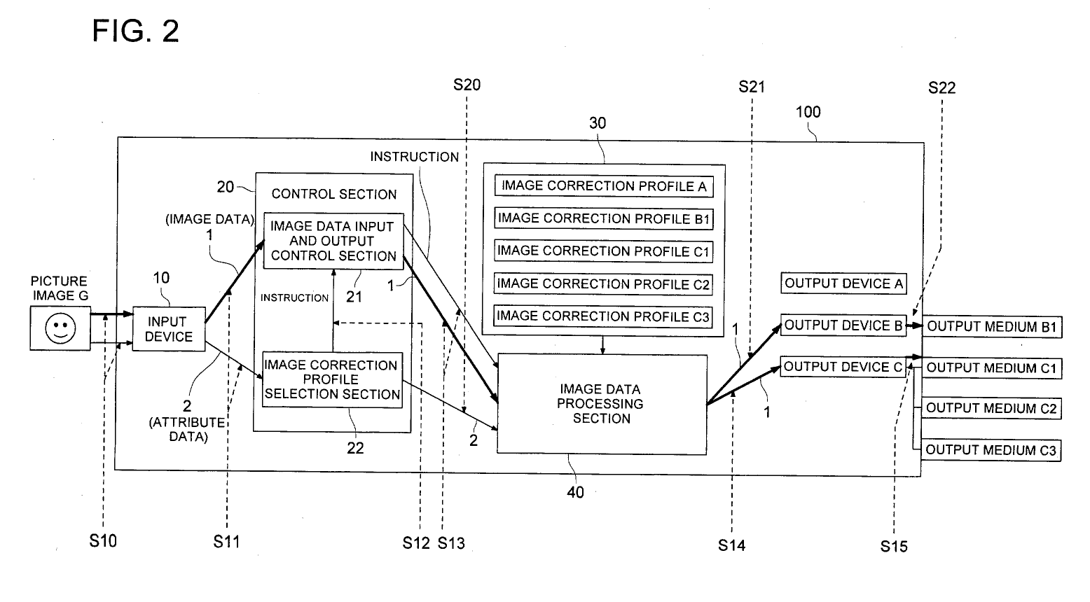

Preferred embodiments of the present invention are described below with reference to the accompanying drawings FIG. 1 and FIG. 2.

In the description below, the image data processing block 40 has the same functions as those of the image processing means according to the present invention. The profile storage block 30 has the same functions as those of the profile recording means of the present invention. The image correction profile selection block 22 has the same functions as those of the output device selecting means, the output medium selecting means, and the profile selecting means of the present invention. The image data input and output control block 21 has the same functions as those of the image processing controlling means, the output controlling means, and the profile content changing means of the present invention.

FIG. 1 is a functional diagram representing the internal configuration of the image reproducing device 100 in accordance with the present invention.

As shown in FIG. 1, the image reproducing device 100 comprises an input device 10, a control block 20, a profile storage block 30, an image data processing block 40, and output devices A, B, and C. The output device B has a removable output medium B1 and the output device C has removable output media C1 to C3. The output devices are not limited to output devices A to C and they can be substituted by the other output devices. Similarly, the output media are not limited to output media B1 and C1 through C3 and they can be substituted by the other output media. Further the output device A can have a removable output medium.

The input device 10 is a publicly known device capable of reading picture images on documents and various objects photo-electrically and outputting then as digital image data. It can be any of such kinds. For example, the input device can be an image reading (input) device (so-called scanner) that applies light to a document by a scanning or surface exposure, reads the reflected or transparent light photo-electrically, a digital camera or digital video camera that reads photographic lights photo-electrically. Digital cameras and digital video cameras also work as input devices.

The input device 10 outputs said image data to the image data input/output control block 21 and attribute data (to be explained later) in said image data and data that specifies output media (to be explained later) to the image correction profile selection block 22.

Here, said attribute data is attached to the image data that is captured by a digital camera and the like and represents a picture image. The attribute data is automatically recorded during photographing or entered by the camera user. The attribute data contains, for example, a ratio of area of a major subject in the image, a focal length, detection of stroboscopic reflection light, a distance to the subject, a shooting scene type, an input device type, a number of pixels of image data, a zooming ratio, an exposure time, a shooting time, a shooting position, and so on.

The data that specifies output media selects an output media to which image data is output among output media B1 and C1 to C3. Without this output media specification data, the image correction profile selection block 22 automatically selects a destination of the image data (output media or output device).

Said attribute data can be attached to the image data as a unique format or independent information file signal and also attached to the image data by being recorded in the existing tag information recording area defined by graphic formats such as JPEG, TIFF, and Exif or in a free accessible area such as a manufacturer note area and a user note area.

Among items in the attribute data, the ratio of area of a major subject in the image can be specified by an absolute size on the image or by information that enables calculation of “a ratio of area of a major subject occupied in the image.” When the size (one side or radius) of a major subject is given in pixels, the ratio of area of a major subject in the image can be calculated in comparison with the number of pixels of the whole image. Further it can be specified to “estimate the size of the major subject in the output image.” Substantial methods are extracting the flesh color from image information and extracting a color or brightness range in the center of the image. Further, it is possible to get information on shooting conditions and estimate the ratio of area of a major subject in the image from the information.

Below will be explained a method of estimating the ratio of area of a major subject in the image from information on shooting conditions such as a focal length, detection of stroboscopic reflection light, a distance to the subject, a shooting scene type, and so on.

For example, when information of a subject area is given in a form that enables calculation of the area size in pixels such as a set of the coordinates of the center and the radius of a circular area or a set of the coordinates of the center, the length, and the width of a rectangular area, the ratio of area of a major subject in the image can be easily calculated in comparison with the number of pixels of the whole image. Therefore, the size of the major subject in the output image can be easily calculated by multiplying the above value by size of an output image estimated or obtained by the already described method. When only the coordinates of the center (one point) of the subject area are given as the information of a subject area, the number of pixels of the major subject area can be determined by calculating average hue and average brightness of some pixels around the specified coordinates and searching pixels whose hue and brightness are within preset tolerances from the average hue and brightness around the specified center (for example, the hue angle difference of 10° C. or less and the brightness difference of 10% or less in the dynamic range).

When information of a shooting scene type, for example, a figure or portrait is given, it is assumed that the major subject is a person's face and that the diameter of the face is about one fourth to one second of the shorter side of the image rectangle. We can assume that the area occupied by the major subject is approximately equivalent to the area of a circle whose diameter is about one third of the shorter side of the image rectangle (in pixels). It is possible to increase the accuracy of estimation by searching a flesh color area of one fourth to one second of the shorter side of the image rectangle. When the shooting scene type is a landscape, the major subject is assumed to occupy about 10% of the image area in most cases. When the shooting scene type is a nightscape, it is assumed that the major subject area is a brighter area in the whole image. When information on a distance between the camera and a subject is given, the ratio of an area of the major subject occupied in the image can be estimated by calculating the size of the face proportional to the distance between the camera and the subject from the lens characteristics of typical compact cameras, assuming that the major subject is a person's face. When information of stroboscopic reflection light, we can estimate an approximate distance between the camera and the subject from the existence and intensity of the reflected stroboscopic reflection light and estimate the ratio of an area of the major subject occupied in the image in the similar manner to the above. It is needless to say that, when two or more pieces of such information are given, the accuracy of the estimation can be increased when they are used in combination for judgment.

Let's return to explain the configuration of the image reproducing device 100. The control block 20 contains an image data input and output control block 21 and an image correction profile selection block 22.

The image data input and output control block 21 receives image data from the input device 10 and sends it to the image data processing block 40. The image data input and output control block 21 orders the image data processing block 40 to change the content of an image correction profile selected by the image correction profile selection block 22 among the image correction profiles A, B1, and C1 through C3 by its Change Profile Content command and to process said image data according to the content of the changed image correction profile.

The image correction profiles respectively contain data (or setting data) used to output optimum images to each output device or medium such as a color conversion table, a gray-scale conversion table, and an edge enhancement image processing parameter.

The output devices and the output media respectively has an image correction profile.

For example, an embodiment of the present invention assigns image correction profile A to output device A, image correction profile B1 to output medium B1 (or output device B), image correction profile C1 to output medium C1, image correction profile C2 to output medium C2, and image correction profile C3 to output medium C3.

For example, an image correction profile for a digital photo printer contains information to control so that images printed out on a digital photo printer may have softer tones than those printed out by an ink-jet printer. Particularly, it is recommendable to make the tone of the low-density area in the finished image softer than that of the image reproduced by the ink jet printer. This is to make the regeneration of tone by the digital photo printer more effective. Further, an image correction profile for an ink jet printer contains information to control so that images printed out on the ink jet printer may make the images printed out on the digital photo printer sharper and more color enhanced. This is to make the regeneration of tone and edge enhancement by the ink jet printer more effective.

The image correction profile selection block 22 selects one medium or device to which image data containing attribute data is output among output devices A to C or output media B1 and C1 to C3 according to the attribute data (which comes from the input device 10) and selects one image correction profile for the selected output device or medium among image correction profiles A, B1, and C1 to C3.

The selection for an output device can be conducted by selecting at least one of plural different additional data and utilizing the selected additional data or by utilizing a combination of plural different additional data.

As a selecting method, for examples, when a face or a part of a figure image occupies a large part of the image data, a silver halide photographic paper printer may be selected or a scene image occupies a large part of the image data, an ink-jet printer or a sublimation printer may be selected. One reason of this selection may be that the silver halide photographic paper printer has a wide range in gradation reproduction for a low image density portion of the image data. In the case that the occupying ratio of a main subject as additional data is judged to be large by the method mentioned above, the silver halide photographic paper printer may be selected in order to reproduce a skin of the figure image with high gradation. Also, in the case that the occupying ratio of a scene image is judged to be large from the data representing a type of a photographed scene, or in the case that a focal length is judged to be large, the inkjet printer may be selected so that a clear vivid image may be enhanced by using inks superior in color tone.

From another aspect, in the case that the same image is printed in plural print sheets, the silver halide photographic paper printer may be selected due to superiority in print speed cost in comparison with the ink jet printer and the sublimation printer. Therefore, when the requested number of prints included in the additional data indicates a large number, it may be preferable to select the silver halide photographic paper printer.

On the other hands, in the case that the pixel number of the image captured by a portable/mobile terminal (a cell phone) with a camera is small, it may be preferable to select the ink jet printer or the sublimation printer which is proper in printing for small pixels or small size image.

As stated above, an image correction profile is automatically selected according to the attribute data. For example, when the image data contains a greater flesh color area and when a focal distance is short, the image correction profile selection block 22 automatically selects photo (silver-salt) printing and consequently selects an image correction profile for photo printing. This is to make tone regeneration of a figure image more effective in photo printing.

The image correction profile selection block 22 sends the selected image correction profile (one of image correction profiles A, B1, and C1 to C3) to the image data input and output control block 21 and orders the image data input and output control block 21 to change the content of the image correction profile according to said attribute data.

When the attribute data contains data indicating that the input device is of the mobile terminal type, the image correction profile selection block 22 selects a preset output device and an image correction profile specific to the mobile terminal (for example, output device B, output medium B1, and image correction profile B1 in this embodiment). When the input device type in the attribute data is not the mobile terminal type, the image correction profile selection block 22 does not select output device B, output medium B1, and image correction profile B1. In other words, output device B, output medium B1, and image correction profile B1 are selected only when the input device is a mobile terminal.

Here, the above portable/mobile terminal functions as an input device such as a mobile phone having a picture transmission function. In this case, image data and the like are sent to the control block 20 via Internet or LAN. The portable/mobile terminal is a communication terminal of the wide-band Code Division Multiple Access system in 3 MHz or preferably 5 MHz bandwidth. This enables rake reception, cell-to-cell soft handover, and fast transmission of high-quality picture images.

When the user enters the specification of a medium to which image data is output, the image correction profile selection block 22 selects an image correction profile for the specified output medium and informs the image data input and output control block 21 of it. Simultaneously, the image correction profile selection block 22 instructs the image data input and output control block 21 to change the content of the selected image correction profile according to the attribute data.

For example, when the camera user selects a portrait printing paper as an output medium for a photo (silver salt) printer (as an output device), portrait image processing on a digital photo printer is set in the image data (as the content of the image correction profile for the portrait printing paper). Further when the shooting attribute data has information that the ratio of the flesh color area is great, the image data input and output control block 21 changes the content of the image correction profile to make the tone of the lower part softer and reproduce a smooth skin image according to the attribute data. Contrarily when the shooting attribute data has information that the ratio of the flesh color area is comparatively less, the image data input and output control block 21 changes the content of the image correction profile to make the image finish harder in portrait image processing.

The above output media specification is entered by the user into the input device 10 or into the image correction profile selection block 22. It is also possible to use this output media specification as one element of the attribute data attached to the image data.

The profile storage block 30 stores various image correction profiles such as image correction profiles A, B1, and C1 to C3.

The image data processing block 40 processes the image data coming from the image data input and output control block 21 according to an image correction profile (one of image correction profiles A, B1, and C1 to C3) instructed by the image data input and output control block 21 and sends the processed image data to an output device (one of output devices A to C) specified by the image data input and output control block 21.

The output devices A to C are printers such as digital photo printers, ink jet printers, and sublimation printers and image displays. In other words, the output devices are output devices for image display. Therefore, all image output media are available when thye receive image data and reproduce visible or latent images. For example, they are printers (image exposure units) using photographic sensitive materials such as silver-salt photographic sensitive materials and electrophotographic sensitive material, thermal printers using thermal recording materials, and display units such as cathode ray tube (CRT) units and liquid crystal display units.

Output media B1 and C1 to C3 are materials to actually display images such as digital photo prints, ink-jet prints, digital sublimation prints, and the like and classified into groups such as media for figures, landscapes, commercials, and printout.

Next, the operation of the image reproducing device 100 in accordance with the present invention will be explained below referring to FIG. 2. FIG. 2 is an operational diagram of the image reproducing method of the image reproducing device 100 in accordance with the present invention.

When receiving a picture image G and information related to the image G (at step S10), the input device 10 converts the picture image G into digital image data 1, sends the data 1 to the image data input and output control block 21 and simultaneously sends the information related to the image G as attribute data 2 (digital data) to the image correction profile selection block 22 (at step S11).

After step S11 is complete, the image correction profile selection block 22 selects one medium or device to which image data 1 containing attribute data is output among output devices A to C or output media B1 and C1 to C3 according to the attribute data 2 (which comes from the input device 10) and selects one image correction profile for the selected output device or medium among image correction profiles A, B1, and C1 to C3 in the profile storage block 3. FIG. 2 assumes output device C, output medium C1, and image correction profile C1 are selected.

Next, the image correction profile selection block 22 tells the image data input and output control block 21 that the image correction profile C1 is selected and instructs the image data input and output control block 21 to change the content of the image correction profile C1 (at step S12).

Then, the image data input and output control block 21 sends the image data 1 (coming from the input device 10) to the image data processing block 40, changes the content of the image correction profile C1 according to the instruction to change the content of the image correction profile C1 from the image correction profile selection block 22, and sends an instruction to process the image data 1 according to the changed image correction profile C1 to the image data processor 40 (at step S13).

Then, the image data processor 40 processes the image data 1 according to the Process Image Data instruction sent from the image data input and output control block 21 and sends the processed image data 1 to the output device C (at step S14).

The output device C receives the processed image data 1 from the image data processor 40 and outputs it to the output medium C1 for reproduction (at step S15).

At step S12, the image correction profile selection block 22 selects output device C, output medium C1, and image correction profile C1. However, it is also possible that the image correction profile selection block 22 selects output device A without an output medium and image correction profile A for the output device A.

When the input device 10 is of the portable/mobile terminal type, the attribute data 2 sets data representing a portable terminal as the input device type. It is also possible that the image correction profile selection block 22 selects output device B, output medium B1, and image correction profile B1 specific for the pre-determined portable/mobile terminal according to the attribute data 2 and sends the result of this selection directly to the image data processor 40 (at step S20). In other words, it is also possible that output device B, output medium B1, and image correction profile B1 are selected (or used) only when the input device 10 is of the portable/mobile terminal type.

In this case, after Step 20, the image data processor 40 processes the image data 1 (sent from the image data input and output control block 21) according to the specified image correction profile B1 and sends the processed image data 1 to the output device B (at step S21). The output device B sends the image data 1 (from the imae data processing block 40) to the output medium B1 for reproduction (at step S22).

It is also possible for the camera user to specify the output medium. When the output medium specification is entered by the user, the image correction profile selection block 22 selects an image correction profile for the specified output medium at step S12, sends the event to the image data input and output control block 21, and instructs the image data input and output control block 21 to change the content of the image correction profile according to the attribute data 2. Then the image data input and output control block 21 performs the same processes as those at steps S13 to S15 on the image data 1 according to the specified image correction profile and the instruction to change the content of the image correction profile.

As explained above, the image reproducing device 100 which is an embodiment of the present invention selects one output device or medium which reproduces the image data 1 among output devices A to C or output media B1 and C1 to C3, and further selects an image correction profile for the selected output device or medium among image correction profiles A, B1, and C1 to C3 in the profile storage block 30. The image reproducing device 100 changes the content of the above selected image correction profile (if necessary) according to the attribute data 2, processes the image data 1 according to the changed image correction profile, and outputs the processed image data 1 to the selected output device or medium.

Further, the image reproducing device 100 can also record the image data 1 in an output medium specified by the user. Also in this case, the image reproducing device 100 processes the image data according to the image correction profile for the specified output medium or according to an image correction profile whose content is changed by the attribute data 2.

Further, when the image reproducing device 100 is equipped with an output device or medium and an image correction profile which are specific to a portable/mobile terminal and when the input device 10 is of the portable/mobile terminal type, the image reproducing device 100 selects the output device or medium and the image correction profile which are specific to a portable/mobile terminal.

Therefore, as the image reproducing device 100 automatically selects an output device and an image correction profile optimum to the image data according to the attribute data 2, any image data obtained under various shooting conditions can be reproduced with high quality by means of the optimum device, output medium, and image correction profile.

Further, also when image data is output to a user-specified output medium, preferable high-quality image reproduction can be done on the specified output medium.

Further, when the input device is of the portable/mobile terminal type, images preferable to image data sent from the portable/mobile terminal is always enabled because the output device or medium and the image correction profile specific to the portable/mobile terminal are pre-installed. Further, the present invention can perform reproduction of images from the portable/mobile terminal collectively on the output device B, medium B1, and image correction profile B1 specific for the portable/mobile terminal. This can increase the efficiency in image reproduction.

The above-described embodiment is a mere example of the image reproducing method and device in accordance with the present invention. However, it is to be understood that the invention is not intended to be limited to this specific embodiment.

Variations in the detailed configuration and operation of the image reproducing device 1 of the present invention may be made by one skilled in the art without departing from the spirit and scope of the present invention.

In accordance with items 1, 2, 4, 5, 6, 10, 11, 13, 14, and 15, the image reproducing device automatically selects an optimum output device or medium and changes the content of an image correction profile for the selected output device or medium. This always enables preferable image reproduction and output of high-quality images.

Further, the output media have been diverse and camera users can select any desired output media. This makes combinations of shooting conditions, output devices, and output media more complicated. In accordance with items 7 to 9 and 16 to 18, the image reproducing device always enables preferable image reproduction and output of high-quality images for various combinations of output media and shooting conditions.

Furthermore, in accordance with items 3 and 12, when said input device is of the portable/mobile terminal type, the image reproducing device sets an output device or medium and an image correction profile for the portable/mobile terminal in advance and can reproduce optimum images from image data coming from the portable/mobile terminal. Consequently, high quality reproduction images can be output. The present invention can perform reproduction of images from the portable/mobile terminal collectively on the output device, medium, and image correction profile specific for the portable/mobile terminal. This can increase the efficiency in image reproduction.

What is claimed is:

1. An image reproducing apparatus, comprising:
an image input device to input image data provided with additional information data;
a plurality of different type image output devices to reproduce an image on a plurality of different kind image recording mediums;
a profile storing device to store a plurality of image correcting profiles each of which is prepared for a corresponding one of the plurality of different type output devices and corrects the image characteristic of the image data to conform with the image reproducing performance of the corresponding image output device;
a selecting device to select one of the plurality of different type image output devices on a basis of the additional information data of the image data and to select one the plurality of image correcting profiles in accordance with the selected image output device;
an image processing device to correct the image data with the selected image correcting profile; and
the selected image output device reproducing an image on a basis of the corrected image data.

2. The image reproducing apparatus of claim 1, wherein the profile storing device further stores a plurality of image correcting profiles each of which is prepared for a corresponding one of the plurality of different kind image recording mediums and corrects the image characteristic of the image data to conform with the image reproducing performance of the corresponding image recording medium, and wherein the selecting device selects the one of the plurality of different type image output devices and one of the plurality of different kind image recording mediums on a basis of the additional information data of the image data.

3. The image reproducing apparatus of claim 1, wherein the additional information data include data about the ratio of area of a major subject in the image, data about the focal length in shooting, data about a shooting scene type, data about an input device type, and data about the number of pixels of image data, and the selecting device selects the one of the plurality of different type image output devices on a basis of at least one data include in the additional information data.

4. The image reproducing apparatus of claim 1, wherein the additional information data include a designating data to designate at least one of an image output device and an image correcting profile and the selecting device select one of the plurality of different type image output devices and one the plurality of image correcting profiles on a basis of the designation of the designating data.

5. The image reproducing apparatus of claim 1, further comprising:
a revising device to revise a content of the selected image correcting profile on a basis of the additional information data.

6. The image reproducing apparatus of claim 1, wherein the plurality of different type image output devices include a specific image output device used exclusively for image data produced by a portable/mobile terminal and the profile storing device stores a specific image correcting profile used exclusively for image data produced by a portable/mobile terminal and wherein when the image input device inputs image data produced by a portable/mobile terminal, the selecting device selects the specific image correcting profile and the specific image output device.

7. An image reproducing method with a plurality of different type image output devices to reproduce an image on a plurality of different kind image recording mediums, comprising the steps of:
inputting image data provided with additional information data;
selecting one of the plurality of different type image output devices stored in a profile storing device on a basis of the additional information data of the image data and to select one a plurality of image correcting profiles in accordance with the selected image output device, wherein each of the plurality of image correcting profiles is prepared for a corresponding one of the plurality of different type output devices and corrects the image characteristic of the image data to conform with the image reproducing performance of the corresponding image output device;
correcting the image data with the selected image correcting profile; and
reproducing an image on a basis of the corrected image data.

8. The image reproducing method of claim 7, wherein the profile storing device further stores a plurality of image correcting profiles each of which is prepared for a corresponding one of the plurality of different kind image recording mediums and corrects the image characteristic of the image data to conform with the image reproducing performance of the corresponding image recording medium, and wherein in the selecting step, one of the plurality of different type image output devices and one of the plurality of different kind image recording mediums are selected on a basis of the additional information data of the image data.

9. The image reproducing method of claim 7, wherein the additional information data include data about the ratio of area of a major subject in the image, data about the focal length in shooting, data about a shooting scene type, data about an input device type, and data about the number of pixels of image data, and the selecting device selects the one of the plurality of different type image output devices on a basis of at least one data include in the additional information data.

10. The image reproducing method of claim 7, wherein the additional information data include a designating data to designate at least one of an image output device and an image correcting profile and the selecting device select one of the plurality of different type image output devices and one the plurality of image correcting profiles on a basis of the designation of the designating data.

11. The image reproducing method of claim 7, further comprising:
a step of revising a content of the selected image correcting profile on a basis of the additional information data.

12. The image reproducing method of claim 7, wherein the plurality of different type image output devices include a specific image output device used exclusively for image data produced by a portable/mobile terminal and the profile storing device stores a specific image correcting profile used exclusively for image data produced by a portable/mobile terminal and wherein when the image input device inputs image data produced by a portable/mobile terminal, the selecting device selects the specific image correcting profile and the specific image output device.
